(19) United States
(12) Patent Application Publication
(10) Pub. No.: US 2025/0392361 A1
(43) Pub. Date: Dec. 25, 2025

(54) METHOD AND APPARATUS OF DYNAMIC ADAPTION OF SPATIAL ELEMENTS

(71) Applicant: LENOVO (BEIJING) LIMITED, Beijing (CN)

(72) Inventors: Hongmei Liu, Beijing (CN); Yuantao Zhang, Beijing (CN); Zhi Yan, Beijing (CN); Yingying Li, Beijing (CN); Haiming Wang, Beijing (CN)

(21) Appl. No.: 18/877,604

(22) PCT Filed: Jun. 23, 2022
(86) PCT No.: PCT/CN2022/100756

§ 371 Date: Dec. 20, 2024

(51) Int. Cl. H04B 7/06; H04L 5/00; H04L 27/26

(52) U.S. Cl. CPC H04B 7/0626; H04L 5/0051; H04L 27/26025

(57) ABSTRACT

Embodiments of the present application are related to a method and apparatus of dynamic adaption of spatial elements. According an embodiment of the present application, an exemplary method includes: receive at least one first signaling indicating a first set of resource element of CSI-RS: receive at least one second signaling indicating antenna port related information; and determine at least one of: a second set of resource element of CSI-RS, application time of the antenna port related information or a set of CSI reference resource based on at least one of the at least one first signaling or the at least one second signaling.

### TECHNICAL FIELD

Embodiments of the present application generally relate to wireless communication technology, especially to a method and apparatus of dynamic adaption of spatial elements.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems. However, wireless communication system still needs to evolve to pursue better service quality, better service experience and lower cost.

For example, regarding spatial elements in the wireless communication system, they generally include antenna element(s), transmission (Tx) radio unit(s) (RU) (s) (with sub-array/full-connection), antenna panel(s), transmit receive point (TRxP) ((s) (co-located or geographically separated from each other), and logical antenna port(s) (corresponding to specific signals and channels, also referred to as logic port(s) or antenna port(s)) etc. According to RAN1 #109e agreement, it is needed to further study techniques and enhancements for the adaptation of spatial elements, which includes but not limited to the following aspects:
impact to user equipment (UE) operations from dynamic adaptation of spatial elements, e.g. measurements, channel state information (CSI) feedback, power control, physical uplink shared channel (PUSCH)/physical downlink shared channel (PDSCH) repetition, sounding reference signal (SRS) transmission, transmission configuration indication (TCI) configuration, beam management, beam failure recovery, radio link monitoring, cell (re) selection, handover, initial access, etc.;
signaling methods, including reduced signaling, for enabling dynamic spatial element adaptation;
   for example, group-common layer 1 (L1) signaling, broadcast signaling, media access control (MAC) control element (CE), etc.
dynamic logical port adaptation and efficient port reconfigurations
   study details of signaling the port (e.g. non-zero-power (NZP) CSI-reference signal (RS) ports) (if required to be known by the UE)
   study dynamic adaptation (including activation/deactivation) of CSI measurement or report configuration for port adaptation

### SUMMARY OF THE DISCLOSURE

One objective of the present application is to provide a technical solution of dynamic adaption of spatial elements, e.g., a technical solution of CSI measurement or report configuration for dynamic adaptation (including activation/deactivation) of antenna port etc.

According to some embodiments of the present application, an exemplary remote apparatus, e.g., a UE, includes a transceiver and a processor coupled to the transceiver. The processor is configured to: receive, via the transceiver, at least one first signaling indicating a first set of resource element of CSI-RS; receive, via the transceiver, at least one second signaling indicating antenna port related information; and determine at least one of: a second set of resource element of CSI-RS, application time of the antenna port related information or a set of CSI reference resource based on at least one of the at least one first signaling or the at least one second signaling.

In some embodiments of the present application, in the case that an antenna port number determined based on the at least one first signaling is smaller than or equal to that determined based on the at least one second signaling, the second set of resource element of CSI-RS is determined as the first set of resource element of CSI-RS.

In some embodiments of the present application, in the case that an antenna port number determined based on the at least one first signaling is larger than that determined based on the at least one second signaling, the second set of resource element of CSI-RS is determined at least based on the at least one second signaling.

In some embodiments of the present application, the antenna port related information indicates a row index of a table for CSI-RS locations within a slot, and the processor is configured to: determine an antenna port number based on the row index.

In some embodiments of the present application, the antenna port related information indicates an antenna port number. According to some embodiments of the present application, the second set of resource element of CSI-RS is determined based on an index of a set of row indices of a table for CSI-RS locations within a slot, and the set of row indices is determined based on the antenna port number. For example, the index is configured, or is predefined to be a lowest index of the set of row indices. According to some embodiments of the present application, the second set of resource element of CSI-RS is determined based on the first set of resource element of CSI-RS and a third set of resource element of CSI-RS, wherein, the third set of resource element of CSI-RS is determined based on an index of a set of row indices in a table for CSI-RS locations within a slot, and the set of row indices is determined by the antenna port number. In the case that the third set of resource element of CSI-RS is a subset of the first set of resource element of CSI-RS, the second set of resource element of CSI-RS is determined as the third set of resource element of CSI-RS; otherwise, the second set of resource element of CSI-RS is determined as a set of resource element associated with a lowest row index of the set of row indices. In the case that there is more than one set of resource element of CSI-RS associated with more than one index of the set of row indices is a subset of the first set of resource element of CSI-RS, the third set of resource element of CSI-RS is determined based on a lowest index of the more than one index.

In some embodiments of the present application, the processor is configured to: receive a third signaling indicating the second set of resource element of CSI-RS associated with the antenna port related information. According to some embodiments of the present application, the second set of resource element of CSI-RS is one of a plurality of sets of resource element of CSI-RS for a CSI-RS resource, and each of the plurality of sets of resource element of CSI-RS is associated with a different antenna port number. According to some embodiments of the present application, the second set of resource element of CSI-RS is one of a plurality of sets of resource element of CSI-RS associated with a CSI-RS resource set, and each CSI-RS resource of the CSI-RS resource set is associated with a different antenna port number.

In some embodiments of the present application, a subcarrier index of the second set of resource element is configured, or is determined by the at least one first signaling, or is determined by a predefined or lowest subcarrier index determined by the at least one first signaling.

In some embodiments of the present application, a symbol index of the second set of resource elements is configured, or is determined by the at least one first signaling, or is determined by a predefined or lowest indexed symbol index determined by the at least one first signaling.

In some embodiments of the present application, the application time of the antenna port related information is determined by a delay predefined or configured between reception of the at least one second signaling and application of the at least one second signaling. According to some embodiments of the present application, the delay is in unit of ms or in unit of slot; and in the case of the unit being slot, a duration of the slot is determined based on a subcarrier spacing (SCS). In an example, the SCS is configured or is determined based on a frequency band or a SCS of an active bandwidth part (BWP). According to some embodiments of the present application, the application time is aligned with a slot boundary or a starting time domain position of a set of CSI-RS resource corresponding to the second set of resource element of CSI-RS.

In some embodiments of the present application, the antenna port related information is valid until new antenna port related information is applied.

In some embodiments of the present application, the at least one second signaling is associated with a predefined or configured duration, and the antenna port related information is valid starting from the application time and ending at the application time plus the duration.

In some embodiments of the present application, default antenna port related information is applicable in the case of no other antenna port related information being valid.

In some embodiments of the present application, the set of CSI reference resource is divided into two subsets of CSI reference resource, and the first subset of CSI reference resource is before application of the at least one second signaling, and the second subset of CSI reference resource is after the application of the at least one second signaling. According to some embodiments of the present application, a measurement result based on the first subset of CSI reference resources is separate from a measurement result based on the second subset of CSI reference resources. According to some embodiments of the present application, in the case that a CSI reporting is after the application of the at least one second signaling, and all CSI reference resources for the CSI reporting only belongs to the first subset of CSI reference resource, the CSI reporting will be dropped. According to some yet other embodiments of the present application, in the case that a CSI reporting is after the application of the at least one second signaling, and CSI reference resources for the CSI reporting belong to the first subset of CSI reference resource and the second subset of CSI reference resource, a report metric of the CSI reporting is based on the second subset of CSI reference resource. According to some embodiments of the present application, in the case that the application time of the at least one second signaling is later than a starting time domain position of a set of RS and is earlier than an ending time domain position of the set of RS, the set of RS is excluded from the first subset of CSI reference resource and the second subset of CSI reference resource.

Some embodiments of the present application also provide a method, which can be performed by a remote apparatus according to an embodiment of the present application. An exemplary method includes: receive at least one first signaling indicating a first set of resource element of CSI-RS; receive at least one second signaling indicating antenna port related information; and determine at least one of: a second set of resource element of CSI-RS, application time of the antenna port related information or a set of CSI reference resource based on at least one of the at least one first signaling or the at least one second signaling.

Some other embodiments of the present application also provide a radio access network (RAN) node, e.g., a gNB, which includes: a transceiver; and a processor coupled to the transceiver, wherein the processor is configured to: transmit, via the transceiver, at least one first signaling indicating a first set of resource element of CSI-RS; transmit, via the transceiver, at least one second signaling indicating antenna port related information; and determine at least one of: a second set of resource element of CSI-RS, application time of the antenna port related information or a set of CSI reference resource based on at least one of the at least one first signaling or the at least one second signaling.

Given the above, embodiments of the present application provide a technical solution of dynamic adaption of spatial elements, e.g., dynamic adaption of CSI pattern and CSI reference resource in response to antenna port number adjustment, and thus will facilitate the deployment and implementation of NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 is a flow chart illustrating an exemplary procedure of a method of dynamic adaption of spatial elements according to some embodiments of the present application.

FIG. 3 is a schematic diagram illustrating CSI-RS pattern determination according to some embodiments of the present application, wherein FIG. 3a illustrates a CSI-RS pattern before the adaption of spatial elements according to some embodiments of the present application and FIG. 3b illustrates a CSI-RS pattern after the adaption of spatial elements according to some embodiments of the present application.

FIG. 4 is a schematic diagram illustrating CSI-RS pattern determination according to some other embodiments of the present application, wherein FIG. 4a illustrates a CSI-RS pattern before the adaption of spatial elements according to some other embodiments of the present application and FIG. 4b illustrates a CSI-RS pattern after the adaption of spatial elements according to some other embodiments of the present application.

FIG. 5 is a schematic diagram illustrating CSI-RS pattern determination according to some yet other embodiments of the present application, wherein FIG. 5a illustrates a CSI-RS pattern before the adaption of spatial elements according to some yet other embodiments of the present application and FIG. 5b illustrates a CSI-RS pattern after the adaption of spatial elements according to some yet other embodiments of the present application.

FIG. 6 is a schematic diagram illustrating a CSI reporting procedure according to some embodiments of the present application

FIG. 7 illustrates a block diagram of an exemplary apparatus of dynamic adaption of spatial elements according to some embodiments of the present application.

FIG. 8 illustrates a block diagram of an exemplary apparatus of dynamic adaption of spatial elements according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

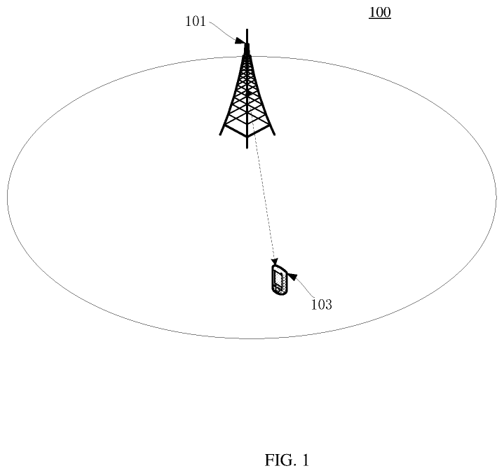

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In addition, a BS 101 may be configured with one transmit-receive point (TRP) (or panel), i.e., in a single-TRP scenario or more TRPs (or panels), i.e., a multi-TRP scenario. That is, one or more TRPs are associated with the BS 101. A TRP can act like a small BS. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

A single TRP can be used to serve one or more UE 103 under the control of a BS 101. In different scenarios, a TRP may be referred to as different terms, which may be represented by a TCI state index or CORESETPoolIndex value etc. It should be understood that the TRP(s) (or panel(s)) configured for the BS 101 may be transparent to a UE 103.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to RAN1 #109e agreement, techniques and enhancements for adaptation of spatial elements, e.g., dynamic adaptation (including activation/deactivation) of CSI measurement or report configuration for port adaptation, will be further studied, which includes but not limited to impact on CSI-RS locations (also referred to as “CSI-RS pattern” or resource element (RE) occupation of CSI-RS) and CSI reporting etc.

Regarding the CSI pattern, legacy 3GPP release, e.g., TS38.211 provides CSI-RS locations within a slot in Table 7.4.1.5.3-1 as follows. Based on the CSI-RS pattern, PDSCH rate matching around CSI-RS, CSI-RS sequence mapping to RE, collision handling with other RS(s) or channel(s) can also be determined.

TABLE 7.4.1.5.3-1
CSI-RS locations within a slot

| | Ports | Density | | | CDM group | | |
|---|---|---|---|---|---|---|---|
| Row | X | ρ | cdm-Type | (k̅, l̅) | index j | k′ | l′ |
| 1 | 1 | 3 | noCDM | (k₀, l₀), (k₀ + 4, l₀), | 0, 0, 0 | 0 | 0 |
| | | | | (k₀ + 8, l₀) | | | |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), | 0, 1, 2, 3 | 0, 1 | 0 |
| | | | | (k₂, l₀), (k₃, l₀) | | | |
| 7 | 8 | 1 | fd-CDM2 | (k₀, l₀), | 0, 1, 2, 3 | 0, 1 | 0 |
| | | | | (k₁, l₀), (k₀, l₀ + 1), | | | |
| | | | | (k₁, l₀ + 1) | | | |
| 8 | 8 | 1 | cdm4-FD2-TD2 | (k₀, l₀), (k₁, l₀) | 0, 1 | 0, 1 | 0, 1 |
| 9 | 12 | 1 | fd-CDM2 | (k₀, l₀), (k₁, l₀), | 0, 1, 2, 3, 4, 5 | 0, 1 | 0 |
| | | | | (k₂, l₀), | | | |
| | | | | (k₃, l₀), (k₄, l₀), (k₅, l₀) | | | |
| 10 | 12 | 1 | cdm4-FD2-TD2 | (k₀, l₀), (k₁, l₀), | 0, 1, 2 | 0, 1 | 0, 1 |
| | | | | (k₂, l₀) | | | |
| 11 | 16 | 1, 0.5 | fd-CDM2 | (k₀, l₀), (k₁, l₀), | 0, 1, 2, 3, | 0, 1 | 0 |
| | | | | (k₂, l₀), | 4, 5, 6, 7 | | |
| | | | | (k₃, l₀), (k₀, l₀ + 1), | | | |
| | | | | (k₁, l₀ + 1), (k₂, l₀ + 1), | | | |
| | | | | (k₃, l₀ + 1) | | | |
| 12 | 16 | 1, 0.5 | cdm4-FD2-TD2 | (k₀, l₀), (k₁, l₀), | 0, 1, 2, 3 | 0, 1 | 0, 1 |
| | | | | (k₂, l₀), (k₃, l₀) | | | |
| 13 | 24 | 1, 0.5 | fd-CDM2 | (k₀, l₀), (k₁, l₀), | 0, 1, 2, 3, | 0, 1 | 0 |
| | | | | (k₂, l₀), (k₀, l₀ + 1), | 4, 5, 6, 7, | | |
| | | | | (k₁, l₀ + 1), (k₂, l₀ + 1), | 8, 9, 10, 11 | | |
| | | | | (k₀, l₁), (k₁, l₁), | | | |
| | | | | (k₂, l₁), (k₀, l₁ + 1), | | | |
| | | | | (k₁, l₁ + 1), (k₂, l₁ + 1) | | | |
| 14 | 24 | 1, 0.5 | cdm4-FD2-TD2 | (k₀, l₀), (k₁, l₀), | 0, 1, 2, 3, 4, 5 | 0, 1 | 0, 1 |
| | | | | (k₂, l₀), (k₀, l₁), | | | |
| | | | | (k₁, l₁), (k₂, l₁) | | | |
| 15 | 24 | 1, 0.5 | cdm8-FD2-TD4 | (k₀, l₀), (k₁, l₀), | 0, 1, 2 | 0, 1 | 0, 1, 2, 3 |
| | | | | (k₂, l₀) | | | |
| 16 | 32 | 1, 0.5 | fd-CDM2 | (k₀, l₀), (k₁, l₀), | 0, 1, 2, 3, | 0, 1 | 0 |
| | | | | (k₂, l₀), | 4, 5, 6, 7, | | |
| | | | | (k₃, l₀), (k₀, l₀ + 1), | 8, 9, 10, 11, | | |
| | | | | (k₁, l₀ + 1), (k₂, l₀ + 1), | 12, 13, 14, 15 | | |
| | | | | (k₃, l₀ + 1), | | | |
| | | | | (k₀, l₁), (k₁, l₁), | | | |
| | | | | (k₂, l₁), (k₃, l₁), | | | |
| | | | | (k₀, l₁ + 1), (k₁, l₁ + 1), | | | |
| | | | | (k₂, l₁ + 1), (k₃, l₁ + 1) | | | |
| 17 | 32 | 1, 0.5 | cdm4-FD2-TD2 | (k₀, l₀), (k₁, l₀), | 0, 1, 2, 3, | 0, 1 | 0, 1 |
| | | | | (k₂, l₀), (k₃, l₀), | 4, 5, 6, 7 | | |
| | | | | (k₀, l₁), (k₁, l₁), | | | |
| | | | | (k₂, l₁), (k₃, l₁) | | | |
| 18 | 32 | 1, 0.5 | cdm8-FD2-TD4 | (k₀, l₀), (k₁, l₀), | 0, 1, 2, 3 | 0, 1 | 0, 1, 2, 3 |
| | | | | (k₂, l₀), (k₃, l₀) | | | |

Each (k̅, l̅) in a given row of Table 7.4.1.5.3-1 corresponds to frequency domain subcarrier index and time domain symbol index within a resource block (RB). A code division multiplexing (CDM) group can be of size 1 (no CDM) or size 2, 4, or 8. The CDM type is provided by the higher layer parameter cdm-Type in the CSI-RS-ResourceMapping IE. The CDM group index j given in Table 7.4.1.5.3-1 corresponds to the time/frequency locations (k̅, l̅) for a given row of the table. The indices k′ and l′ index resource elements within a CDM group. The time-domain locations l₀∈{0, 1, . . . , 13} and l₁∈{2, 3, . . . , 12} are provided by the higher-layer parameters firstOFDMSymbolInTimeDomain and firstOFDMSymbolInTimeDomain2, respectively, in the CSI-RS-ResourceMapping IE or the CSI-RS-ResourceConfigMobility IE and defined relative to the start of a slot. The frequency-domain location, e.g., k₀, k₁, k₂ or k₃ is given by a bitmap provided by the higher-layer parameter frequencyDomainAllocation in the CSI-RS-ResourceMapping IE or the CSI-RS-ResourceConfigMobility IE with the bitmap.

It can be seen from Table 7.4.1.5.3-1, for a number of antenna ports, the mapping between CSI-RS to REs can be different dependent on the CDM-type, time domain symbol allocation and frequency subcarrier allocation. There may be multiple CSI-RS patterns for a certain number of antenna ports in view of different CDM-types, symbol allocations and frequency subcarrier allocations etc. Thus, when the number of spatial elements is adapted or adjusted, for example, the number of antenna ports is reduced for network energy saving, which CSI-RS pattern to be used should be determined.

Regarding CSI reporting, the CSI reference resource is defined as follows according to TS38.214:

In the frequency domain, the CSI reference resource is defined by the group of downlink physical resource blocks corresponding to the band to which the derived CSI relates.
In the time domain, the CSI reference resource for a CSI reporting in uplink slot n′ is defined by a single downlink slot

$$n - {n}_{CSI \_ ref} - {K}_{offset} \cdot \frac{{2}^{{μ}_{DL}}}{{2}^{{μ}_{{K}_{offset}}}} ,$$

where K_{offset} is a parameter configured by higher layer as specified in clause 4.2 of [6 TS 38.213], and where μ_{K}_{_{offset}} is the subcarrier spacing configuration for K_{offset} with a value of 0 for frequency range 1,

$$where n = ⌊ {n}^{′} \cdot \frac{{2}^{{μ}_{DL}}}{{2}^{{μ}_{UL}}} ⌋ + ⌊ ( \frac{{N}_{slot , offset , UL}^{CA}}{{2}^{{μ}_{offset , DL}}} - \frac{{N}_{slot , offset , DL}^{CA}}{{2}^{{μ}_{offset , DL}}} ) \cdot {2}^{{μ}_{DL}} ⌋$$

and μ_{DL} and μ_{UL} are the subcarrier spacing configurations for downlink (DL) and uplink (UL), respectively, and N_{slot,offset}^{CA} and μ_{offset} are determined by higher-layer configured ca-SlotOffset for the cells transmitting the uplink and downlink, as defined in clause 4.5 of [4, TS 38.211]
where for periodic and semi-persistent CSI reporting
if a single CSI-RS/synchronization signal (SS)/physical broadcast channel (PBCH) blocks (SSB) resource is configured for channel measurement n_{CSI_ref} is the smallest value greater than or equal to 4·2^{μ}^{_{DL}}, such that it corresponds to a valid downlink slot, or
if multiple CSI-RS/SSB resources are configured for channel measurement n_{CSI_ref} is the smallest value greater than or equal to 5·2^{μ}^{_{DL}}, such that it corresponds to a valid downlink slot.
where for aperiodic CSI reporting, if the UE is indicated by the DCI to report CSI in the same slot as the CSI request, n_{CSI_ref} is such that the reference resource is in the same valid downlink slot as the corresponding CSI request, otherwise n_{CSI_ref} is the smallest value greater than or equal to

$$⌊ {Z}^{′} / {N}_{symb}^{slot} ⌋ ,$$

such that slot n-n_{CSI_ref} corresponds to a valid downlink slot, where Z′ corresponds to the delay requirement as defined in Clause 5.4.
when periodic or semi-persistent CSI-RS/CSI-IM or SSB is used for channel/interference measurements, the UE is not expected to measure channel/interference on the CSI-RS/CSI-IM/SSB whose last OFDM symbol is received up to Z′ symbols before transmission time of the first OFDM symbol of the aperiodic CSI reporting.

It can be seen that, when CSI reporting is performed at uplink slot n, the corresponding downlink slot carrying CSI-RS/SSB should be not later than (n-n_CSI). However, there may be different n_CSI values in different scenarios. If time domain restriction is configured, then the CSI reporting is based on a single measurement. Otherwise, it is up to UE implementation on averaging of measurement results at different time instances. Thus, when the number of spatial elements is adjusted, for example, the number of antenna ports is reduced for network energy saving, how to define the CSI reference resources should also be solved.

In addition, the mapping between antenna elements and antenna ports may also change when the number of antenna ports is adjusted. There may be a delay between the reception of the signaling indicating the number of antenna ports being adjusted and the application of this signaling. Thus, yet another issue, i.e., when the adjusted antenna port number will be applicable in the UE side should also be solved.

At least considering the above technical problems, embodiments of the present application propose a technical solution of dynamic adaption of spatial elements, e.g., a method and apparatus of dynamic adaption of spatial elements.

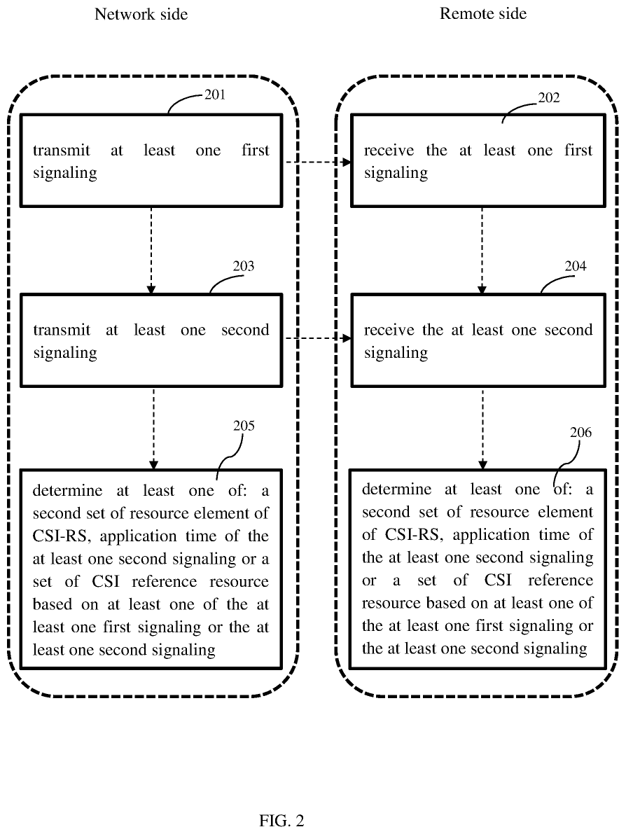

FIG. 2 is a flow chart illustrating an exemplary procedure of a method of dynamic adaption of spatial elements according to some embodiments of the present application. Although the method is illustrated in a system level between a RAN node, e.g., a gNB and a remote apparatus, e.g., a UE, persons skilled in the art should understand that the method implemented in the RAN node and the remote apparatus can be separately implemented and/or incorporated by other apparatus with the like functions.

Referring to in FIG. 2, the RAN node, e.g., a gNB may configure a first set of resource element of CSI-RS (also referred to as “CSI-RS resource element”) for a UE as in legacy technology. In step 201, the RAN node will transmit at least one first signaling, e.g., a radio resource control (RRC) signaling or a MAC CE indicating the first set of resource element of CSI-RS to the UE. Accordingly, the UE will receive the at least one first signaling in step 202. The at least one first signaling may indicate the time domain location(s), e.g., symbol index 1, the frequency domain location(s), e.g., subcarrier index k, and information associated with the row index in a table of CSI-RS locations within a slot, e.g., Table 7.4.1.5.3-1 specified in TS38.211 as illustrated above (such as density, CDM type, number of antenna ports), so that a CSI RS pattern can be determined. Persons skilled in the art should well know that as the evolution of 3GPP technology, Table 7.4.1.5.3-1 may also evolve into a different table. Thus, the table of CSI-RS locations within a slot in the present application should be limited to Table 7.4.1.5.3-1.

In addition, persons skilled in the art should well know that, herein, the wordings, such as the first, the second and the third etc., are only used to distinguish similar features or elements etc., for clearness, and should not be deemed as limitation to the scope of the technical solutions. In addition, the wording “a set of” or the like means “one or more” or “at least one” or the like. For example, the first set of resource element of CSI-RS means one or more resource elements of CSI-RS or at least one resource element of CSI-RS.

The RAN node may dynamically adjust the spatial elements, e.g., adjust the number of antenna port. Herein, considering the CSI-RS pattern, and CSI measurement and reporting, the antenna port can also be referred to as CSI-RS antenna port or CSI-RS port. In step 203, the RAN node will transmit at least one second signaling indicating antenna port related information to the UE to indicate the adjustment. Accordingly, the UE will receive the at least one second signaling indicating the antenna port related information in step 204.

The at least one second signaling can be configured per cell or per TRP. Exemplary at least one second signaling may be downlink control information (DCI), MAC CE or the combination of them. The type of DCI is various, e.g., group common DCI or aperiodic DCI etc. An exemplary aperiodic DCI is a DCI triggering a CSI reporting and the corresponding aperiodic CSI-RS transmission, wherein the aperiodic CSI-RS transmission is associated with an antenna port number. In some scenarios, there may be more than one set of such at least one second signaling respectively indicating the antenna port related information to the UE for different time instances. Accordingly, if there is more than one set of such at least one second signaling indicating the antenna port related information at the same time, the latest set of at least one second signaling will be applied according to some embodiments of the present application. However, in some other embodiments of the present application, group common DCI may always have the highest priority regardless of whether it is the latest signaling; and in the case that there is more than one group common DCI at the same time, the latest group common DCI will be applied. In addition, although the wording “adjustment” or “updated” or the like is used, it does not mean the adjusted spatial elements must be different from the previous one(s). The adjusted spatial elements may be the same as or different from those before the adjustment.

In response to the spatial elements being adjusted, the RAN node and the UE will perform corresponding operations to adapt the adjusted spatial elements, which are various according to some embodiments of the present application. For example, in step 205, the RAN node will determine at least one of: a second set of resource element of CSI-RS, application time of the antenna port related information (or application time of the at least one second signaling) or a set of CSI reference resource based on at least one of the at least one first signaling or the at least one second signaling. Similarly, in step 206, the UE will also determine at least one of: a second set of resource element of CSI-RS, application time of the antenna port related information or a set of CSI reference resource based on at least one of the at least one first signaling or the at least one second signaling. That is, in response to the antenna port related information, the RAN side and UE side may respectively determine or update or define the CSI-RS pattern (or the second set of resource element of CSI-RS), the application time of the antenna port related information (or the at least one second signaling) and CSI reference resource(s) etc., which will be specifically illustrated in view of various embodiments of the present application in the following. Persons skilled in the art should well know that due to the consistency between the network side and remote side, although some embodiments are illustrated only concerning on one side as an example, the corresponding operations in the other side should also be determined except for special operations.

### Determination of the Application Time

There may be antenna elements to antenna ports remapping in response to reception of the antenna port related information indicated in the at least one second signaling in the UE side, which will cost time. Thus, the reception of the at least one second signaling may not mean the application of the at least one second signaling in the UE side. According to some embodiments of the present application, a specific delay will be predefined or configured so that the application time of the antenna port related information (or the at least one second signaling) can be uniquely determined in the network side and the UE side.

In some embodiments of the present application, the delay is in unit of ms or in unit of slot. In the case of the unit being slot, the duration of the slot is determined based on a SCS. An exemplary SCS is configured or is determined based on a frequency band or a SCS of an active BWP. The determined application time will be aligned with a slot boundary or a starting time domain position of a set of CSI-RS resource corresponding to the second set of resource element of CSI-RS. For example, the reception of the at least one second signaling is at slot n with 15 KHz and the delay is 7 slots for 30 KHz SCS, wherein 7 slots for 30 KHz SCS are 3.5 slots with 15 KHz. If the transmission of CSI-RS is associated with SCS=15 KHz, to align the slot boundary, the actual delay should be ceil (3.5)=4 slot for 15 KHz Then the at least one second signaling or the antenna port relation information will be applied at slot (n+4) with 15 KHz SCS.

Regarding the time duration that the at least one second signaling or antenna port related information is applicable, there are also several solutions. In some embodiments of the present application, the at least one second signaling or the antenna port related information will be valid until a new at least one second signaling or new antenna port related information is applied. In some other embodiments of the present application, the at least one second signaling (or the antenna port related information) will be associated with a predefined or configured duration, and the at least one second signaling (or the antenna port related information) will be valid starting from the application time and ending at the application time plus the duration.

In some scenarios, default antenna port related information may be configured, e.g., by the at least one first signaling, or be predefined in specification, or be assumed to be one of possible configured antenna port related values. In the case that there is no other antenna port related information is applicable, the default antenna port related information will be applied. For example, the antenna port related information may be invalid after the predefined or configured duration while no new antenna port information is applied in the UE side. Then, it is assumed that a default antenna port related information is applied.

### Determination of CSI-RS Pattern

According to some embodiments of the present application, the second set of resource element of CSI-RS can be determined based on the at least one first signaling and the at least one second signaling (the applied one, hereafter the same). That is, the new or updated CSI-RS pattern will be determined based on the at least one first signaling and the at least one second signaling. Based on the determined CSI-RS pattern, PDSCH rate matching around CSI-RS, CSI-RS sequence mapping to RE, and collision handling with other RS(s) or channel(s) can also be determined.

The antenna port related information indicated in the at least one second signaling is various. For example, the at least one second signaling may directly indicate the adjusted or adapted antenna port number. In another example, the at least one second signaling may indicate a row index in the table of CSI-RS locations within a slot. Since a row index is associated with an antenna port number, the antenna port number will be determined based on the indicated row index. If the antenna port number for a specific UE is larger than the indicated port number, the antenna port number will be reduced to the indicated port number.

In some embodiments of the present application, in the case that an antenna port number determined based on the at least one first signaling is smaller than or equal to that determined based on the at least one second signaling, the second set of resource element of CSI-RS will be determined as the first set of resource element of CSI-RS. That is, the CSI-RS pattern will not change. In the case that an antenna port number determined based on the at least one first signaling is larger than that determined based on the at least one second signaling, the second set of resource element of CSI-RS will be determined at least based on the at least one second signaling. That is, the CSI-RS pattern will be updated or determined in response to the antenna port related information. In conclusion, when the antenna port number determined from the at least one second signaling is not smaller than that determined from the at least one first signaling, the CSI-RS pattern determined based on the at least one first signaling is still applicable; otherwise, determining or adjusting or updating a new CSI-RS pattern is necessary.

The determined CSI-RS pattern will be consistent with the indicated row index. The subcarrier index for determining the CSI-RS pattern is configured, e.g., by the at least one second signaling, or is determined based on the at least one first signaling, or is a predefined value or lowest subcarrier index determined based on the at least one first signaling. Similarly, the symbol index for determining the CSI-RS pattern is configured, e.g., by the at least one second signaling, or is determined based on the at least one first signaling, or is a predefined value or the lowest symbol index determined based on the at least one first signaling.

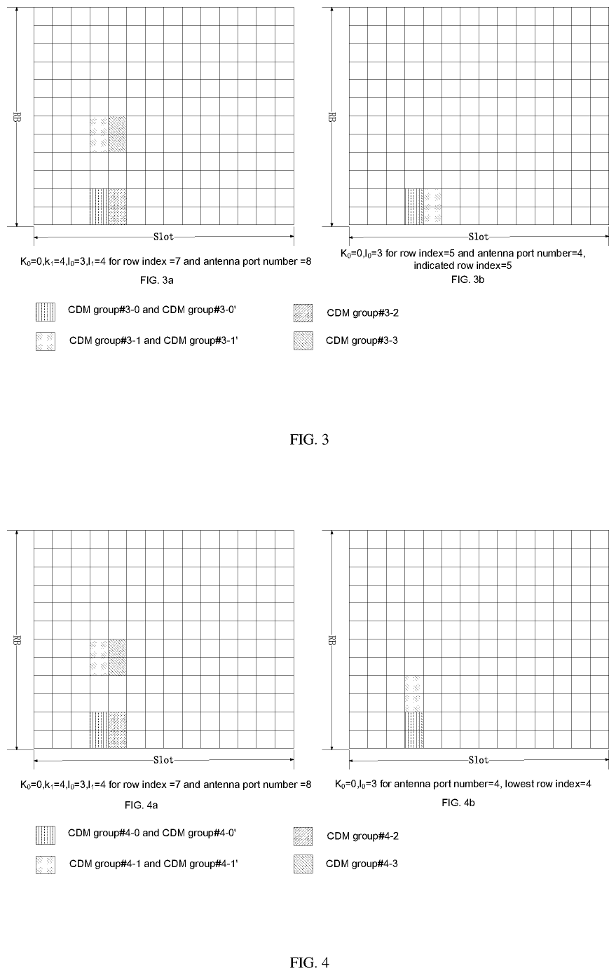

FIG. 3 is a schematic diagram illustrating CSI-RS pattern determination according to some embodiments of the present application, wherein FIG. 3a illustrates a CSI-RS pattern before the adaption of spatial elements according to some embodiments of the present application and FIG. 3b illustrates a CSI-RS pattern after the adaption of spatial elements according to some embodiments of the present application.

Firstly, referring to FIG. 3a, regarding the CSI-RS pattern before the adaption of spatial elements, it is determined based on the at least one first signaling as legacy. For example, the at least one first signaling may indicate that the row index is 7, k₀ is 0, k₁ is 4, l₀ is 3 and l₁ is 4. Then, according to Table 7.4.1.5.3-1, the antenna port number is determined to be 8 based on the at least one first signaling, and four CDM groups, e.g., CDM group #3-0, CDM group #3-1, CDM group #3-2, CDM group #3-3 will be determined in FIG. 3a.

Then, the network side may adjust the antenna port number, e.g., reduce the antenna port number to be 4 to save power. The network side may send at least one second signaling indicating a row index being 5 corresponding to the antenna port number being 4. Then, according to Table 7.4.1.5.3-1, the antenna port number is determined to be 4 in the UE side as shown in FIG. 3b, which is smaller than the previous antenna port number, and thus the new CSI-RS pattern will be determined. The frequency subcarrier index k for determining the CSI-RS pattern can be configured in the at least one second signaling, or is determined based on the at least one first signaling, or is a predefined value or the lowest subcarrier index determined based on the at least one first signaling. Similarly, the time domain symbol index 1 for determining the CSI-RS pattern is configured, e.g., by the at least one second signaling, or is determined based on the at least one first signaling, or is a predefined value or is the lowest symbol index determined based on the at least one first signaling. According to Table 7.4.1.5.3-1, only k₀ and l₀ will be determined for the row index being 5 in FIG. 3b, wherein k₀ is determined to be 0 (the lowest subcarrier index configured by the at least one first signaling) and l₀ is determined to be is 3 (the lowest symbol index configured by the at least one first signaling). Accordingly, only two CDM groups, e.g., CDM group #3-0′ and CDM group #3-1′ will be determined in FIG. 3b.

However, different from indicating a row index, the CSI-RS pattern determination will become a little complexed when the at least one second signaling directly indicates an antenna port number because an antenna port number may corresponding to more than one row index. For example, the antenna port number being 8 may correspond to the row index 6, 7 or 8. Thus, a single row index for determining the new CSI-RS pattern will be determined from a set of row indices determined based on the indicated antenna port number. For example, the single row index can be configured, e.g., by the at least one second signaling, or is predefined to be the lowest index of the set of row indices, or is a row index whose corresponding RE is a subset of the REs configured in the at least one first signaling of a set of row indices. Accordingly, the new CSI-RS pattern will be determined based on the single row index.

Similarly, the determined CSI-RS pattern will be consistent with the row index determined based on the antenna port number. The subcarrier index for determining the CSI-RS pattern is configured, e.g., by the at least one second signaling, or is determined based on the at least one first signaling, or is a predefined value or is the lowest subcarrier index determined based on the at least one first signaling. The symbol index for determining the CSI-RS pattern is configured, e.g., by the at least one second signaling, or is determined based on the at least one first signaling, or is a predefined value or is the lowest symbol index determined based on the at least one first signaling.

FIG. 4 is a schematic diagram illustrating CSI-RS pattern determination according to some other embodiments of the present application, wherein FIG. 4a illustrates a CSI-RS pattern before the adaption of spatial elements according to some other embodiments of the present application and FIG. 4b illustrates a CSI-RS pattern after the adaption of spatial elements according to some other embodiments of the present application.

Firstly, referring to FIG. 4a, regarding the CSI-RS pattern before the adaption of spatial elements, it is determined based on the at least one first signaling as legacy. For example, the at least one first signaling may indicate that the row index is 7, k₀ is 0, k₁ is 4, l₀ is 3 and l is 4. Then, according to Table 7.4.1.5.3-1, the antenna port number is determined to be 8 based on the at least one first signaling, and then four CDM groups, e.g., CDM group #4-0, CDM group #4-1, CDM group #4-2, and CDM group #4-3 will be determined in FIG. 4a.

Then, the network side may adjust the antenna port number, e.g., reduce the antenna port number to be 4 to save power. The network side may directly send at least one second signaling indicating the antenna port number being 4. Then, according to Table 7.4.1.5.3-1, the row index corresponding to the antenna port number being 4 is determined to be 4 or 5 in the UE side, which is smaller than the previous antenna port number, and thus a new CSI-RS pattern will be determined. A single row index for determining the adjusted CSI-RS pattern will be determined from the set of row indices including row index being 4 and row index being 5. For example, the single row index can be determined to be the lowest one of the set of row indices, i.e., 4. The frequency subcarrier index k for determining the CSI-RS pattern can be configured in the at least one second signaling, or is determined by the at least one first signaling, or is a predefined value or the lowest subcarrier index determined based on the at least one first signaling. Similarly, the time domain symbol index 1 will be determined. According to Table 7.4.1.5.3-1, only k₀ and l₀ will be determined for the row index being 4 in FIG. 4b, wherein, k₀ is 0 and l₀ is 3. Accordingly, only two CDM groups, e.g., CDM group #4-0′ and CDM group #4-1′ will be determined in FIG. 4b.

According to some other embodiments of the present application, when determining the single row index from the set of row indices determined based on the indicated antenna port number, whether a set of resource element of CSI-RS determined based on a row index is a subset of the first set of resource element of CSI-RS will be firstly considered. For example, the CSI-RS pattern will be determined based on the first set of resource element of CSI-RS and a third set of resource element of CSI-RS. The third set of resource element of CSI-RS is determined based on an index of a set of row indices in a table for CSI-RS locations within a slot, and the set of row indices is determined by the indicated antenna port number. In the case that the third set of resource element of CSI-RS is a subset of the first set of resource element of CSI-RS, the second set of resource element of CSI-RS is determined as the third set of resource element of CSI-RS; otherwise, the second set of resource element of CSI-RS is determined as a set of resource element associated with the lowest row index of the set of row indices. In the case that there is more than one set of resource element of CSI-RS being a subset of the first set of resource element of CSI-RS, the third set of resource element of CSI-RS is determined based on the lowest index of the more than one row index associated with the more than one set of resource element of CSI-RS.

Similarly, the determined CSI-RS pattern based on the first set and third set of resource element of CSI-RS will be consistent with the row index determined based on the indicated antenna port number.

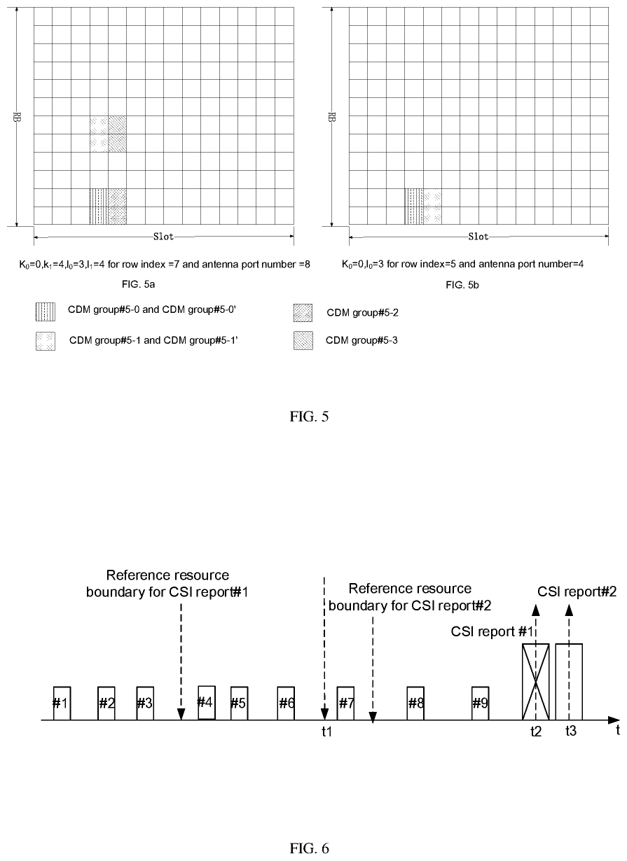

FIG. 5 is a schematic diagram illustrating CSI-RS pattern determination according to some yet other embodiments of the present application, wherein FIG. 5a illustrates a CSI-RS pattern before the adaption of spatial elements according to some yet other embodiments of the present application and FIG. 5b illustrates a CSI-RS pattern after the adaption of spatial elements according to some yet other embodiments of the present application.

Firstly, referring to FIG. 5a, regarding the CSI-RS pattern before adjusting the spatial elements, it is determined based on the at least one first signaling as legacy. For example, the at least one first signaling may indicate that the row index is 7, k₀ is 0, k₁ is 4, l₀ is 3 and l₁ is 4. Then, according to Table 7.4.1.5.3-1, the antenna port number is determined to be 8 based on the at least one first signaling, and four CDM groups, e.g., CDM group #5-0, CDM group #5-1, CDM group #5-2, and CDM group #5-3 will be determined in FIG. 5a.

Then, the network side may adjust the antenna port number, e.g., reduce the antenna port number to be 4 to save power. The network side may directly send at least one second signaling indicating the antenna port number being 4. Then, according to Table 7.4.1.5.3-1, the row index corresponding to the antenna port number being 4 is determined to be 4 or 5 in the UE side, which is smaller than the previous antenna port number, and thus a new CSI-RS pattern will be determined. The new CSI-RS pattern will be determined based on the first set of resource element of CSI-RS and a third set of resource element of CSI-RS, wherein the third set of resource element of CSI-RS is determined based on a row index of a set of row indices including the row index being 4 and the row index being 5. According to Table 7.4.1.5.3-1, since only the set of resource element of CSI-RS determined by the row index being 5 is a subset of the first set of resource element of CSI-RS, the second set of resource element of CSI-RS will be determined as the third set of resource element of CSI-RS determined by the row index being 5. Accordingly, only two CDM groups, e.g., CDM group #5-0′ and CDM group #5-1′ will be determined in FIG. 5b.

In some other embodiments of the present application, besides the at least one second signaling indicating the antenna port related information, the network side may indicate the CSI-RS pattern that adapts the adjusted spatial elements, e.g., by a third signaling. An exemplary third signaling is a DCI or MAC CE etc. That is, the network side may transmit a third signaling indicating the second set of resource element of CSI-RS associated with the antenna port related information. Regarding the subcarrier index and symbol index for determining the CSI-RS pattern, they are configured or determined in the same manners as the above illustrated, e.g., being configured, or being determined based on the at least one first signaling, or being predefined or being the lowest subcarrier index or the lowest symbol index determined based on the at least one first signaling.

In some scenarios, the second set of resource element of CSI-RS is one of a plurality of sets of resource element of CSI-RS for a CSI-RS resource, and each of the plurality of sets of resource element of CSI-RS is associated with a different antenna port number. That is, for a CSI-RS resource, there can be different CSI-RS patterns for different antenna port numbers configured by the third signaling. In response to the at least one second signaling being applied, the corresponding CSI-RS pattern will be selected.

There can also be a CSI-RS resource set (or group or subgroup) containing multiple CSI-RS resources, and different CSI-RS resources are associated with different antenna port numbers. Such a CSI-RS resource set can be associated with the purpose of “port adjustment.” For example, the second set of resource element of CSI-RS is one of a plurality of sets of resource element of CSI-RS associated with a CSI-RS resource set, and each CSI-RS resource of the CSI-RS resource set is associated with a different antenna port number. In response to the at least one second signaling being applied, the corresponding CSI-RS resource will be selected.

### CSI Measurement and Reporting

As stated above, one or more CSI reference resources are defined for CSI measurement, wherein multiple RSs, e.g., downlink CSI-RS/SSB at different time instances may be used for averaging the CSI measurement results. In response to the application of the at least one second signaling, the CSI reference resource definition may also change to adapt the antenna port related information.

In some embodiments of the present application, the set of CSI reference resource is divided into two subsets of CSI reference resource, wherein the first subset of CSI reference resource is before the application of the at least one second signaling, and the second subset of CSI reference resource is after the application of the at least one second signaling. The first subset of CSI reference resource may include none, or a part or all of the set of CSI reference resource. Consequently, the second subset of CSI reference resource may include all, or a part or none of the set of CSI reference resource. For example, for a CSI reporting with a reference resource boundary before the application of the at least one second signaling, all CSI reference resources of the set of CSI reference resource belong to the first subset, while for a CSI reporting with a reference resource boundary after the application of the at least one second signaling, a part or all CSI reference resources of the set of CSI reference resource belong to the second subset. For a set of RS, e.g., a set of RS containing at least one CSI-RS/SSB/SRS resource, in the case that the application time of the at least one second signaling is later than the starting time domain position of the set of RS and is earlier than the ending time domain position of the set of RS, the set of RS will be excluded from the first subset of CSI reference resource and the second subset of CSI reference resource. That is, the set of RS will not be defined for CSI measurement.

According to some embodiments of the present application, the measurement result based on the first subset of CSI reference resources is separate from a measurement result based on the second subset of CSI reference resources. That is, there is no averaging of the measurement result based on the first subset of CSI reference resource and that based on the second subset of CSI reference resource. The CSI measurement to be reported is only based on the second subset of CSI reference resource.

In the case that a CSI reporting is after the application of the at least one second signaling, and all CSI reference resources for the CSI reporting only belongs to the first subset of CSI reference resource, the CSI reporting will be dropped. In the case that a CSI reporting is after the application of the at least one second signaling, and CSI reference resources for the CSI reporting belong to the first subset of CSI reference resource and the second subset of CSI reference resource, a report metric of the CSI reporting is based on the second subset of CSI reference resource. That is, only the CSI measurement result based on the second subset of CSI reference resource will be reported in the case that a CSI reporting is after the application of the at least one second signaling, and the CSI measurement result based on the first subset of CSI reference resource will not be reported.

FIG. 6 is a schematic diagram illustrating a CSI reporting procedure according to some embodiments of the present application.

Referring to FIG. 6, there will be two CSI reporting, e.g., CSI report #1 and CSI reporting #2, which are expected to be transmitted at time t2 and t3 respectively. According to the reference resource boundary for CSI report #1, CSI reference resource #1, #2, #3 are defined for CSI reporting #1. According to reference resource boundary for CSI report #2, CSI reference resource #1, #2, #3, #4, #5, #6, #7 are defined for CSI reporting #2, that is, CSI reference resource #1, #2, #3, #4, #5, #6, #7 can be averaged to derive CSI report #2. CSI reference resource #8, #9 are out of the reference resource boundary for CSI report #1 and CSI report #2 and will not be defined for any one of CSI report #1 and CSI report #2.

At time t1, at least one signaling indicating antenna port related information is applied. Since all the CSI reference resources for CSI report #1 are before the application of the at least one signaling, all CSI reference resource #1, #2, #3 are valid reference resource for CSI report #1 and can be averaged to derive CSI report #1. However, the transmission time (or reporting time) t2 of CSI report #1 is later than the application time t1. Thus, CSI report #1 will be dropped and will not be reported to the network side. For CSI report #2, CSI reference resource #1, #2, #3, #4, #5, #6 are before the application time t1 of the at least one signaling, and CSI reference resource #7 is after the application time t1 of the at least one signaling. Thus, CSI reporting #2 will be reported, while the report metric of CSI reporting #2 will be only based on CSI reference resource #7. That is, only CSI reference resource #7 is valid reference resource for CSI report #2 and the measurement result based on CSI reference resource #1, #2, #3, #4, #5, #6 will not be considered for CSI report #2 and will not be averaged with that based on CSI reference resource #7.

Besides the methods, embodiments of the present application also propose an apparatus of dynamic adaption of spatial elements.

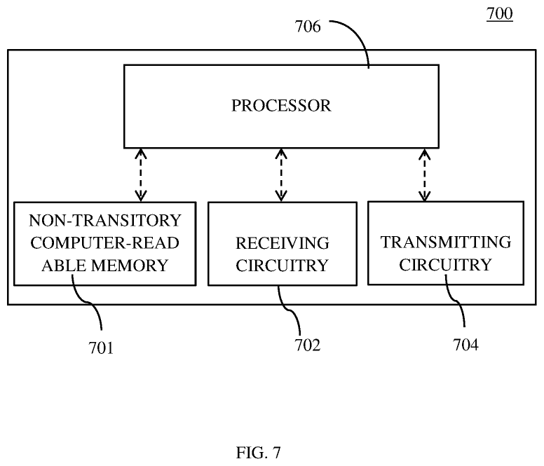

For example, FIG. 7 illustrates a block diagram of an apparatus of dynamic adaption of spatial elements 700 according to some embodiments of the present application.

As shown in FIG. 7, the apparatus 700 may include at least one non-transitory computer-readable medium 701, at least one receiving circuitry 702, at least one transmitting circuitry 704, and at least one processor 706 coupled to the non-transitory computer-readable medium 701, the receiving circuitry 702 and the transmitting circuitry 704. The at least one processor 706 may be a CPU, a DSP, a microprocessor etc. The apparatus 700 may be a RAN node, e.g., a gNB or a remote apparatus, e.g., a UE configured to perform a method illustrated in the above or the like.

Although in this figure, elements such as the at least one processor 706, transmitting circuitry 704, and receiving circuitry 702 are described in the singular, the plural is contemplated unless a limitation to the singular is explicitly stated. In some embodiments of the present application, the receiving circuitry 702 and the transmitting circuitry 704 can be combined into a single device, such as a transceiver. In certain embodiments of the present application, the apparatus 700 may further include an input device, a memory, and/or other components.

In some embodiments of the present application, the non-transitory computer-readable medium 701 may have stored thereon computer-executable instructions to cause a processor to implement the method with respect to the RAN node, e.g., the gNB as described above. For example, the computer-executable instructions, when executed, cause the processor 706 interacting with receiving circuitry 702 and transmitting circuitry 704, so as to perform the steps with respect to the RAN node as depicted above.

In some embodiments of the present application, the non-transitory computer-readable medium 701 may have stored thereon computer-executable instructions to cause a processor to implement the method with respect to the remote apparatus, e.g., the UE as described above. For example, the computer-executable instructions, when executed, cause the processor 706 interacting with receiving circuitry 702 and transmitting circuitry 704, so as to perform the steps with respect to the remote apparatus as illustrated above.

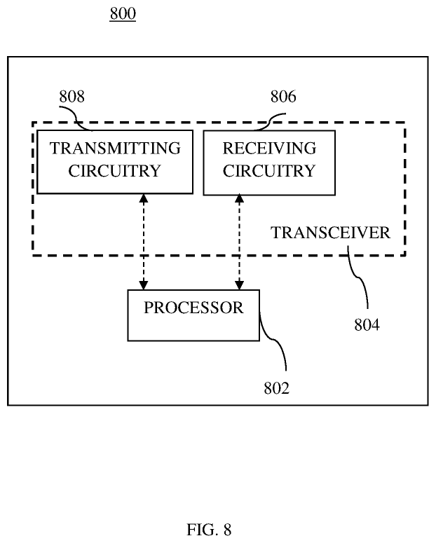

FIG. 8 is a block diagram of an apparatus of dynamic adaption of spatial elements 800 according to some other embodiments of the present application.

Referring to FIG. 8, the apparatus 800, for example a gNB or a UE may include at least one processor 802 and at least one transceiver 804 coupled to the at least one processor 802. The transceiver 804 may include at least one separate receiving circuitry 806 and transmitting circuitry 804, or at least one integrated receiving circuitry 806 and transmitting circuitry 804. The at least one processor 802 may be a CPU, a DSP, a microprocessor etc.

According to some embodiments of the present application, the apparatus 800 is a RAN node, e.g., a gNB, which includes: a transceiver; and a processor coupled to the transceiver, wherein the processor is configured to: transmit, via the transceiver, at least one first signaling indicating a first set of resource element of CSI-RS; transmit, via the transceiver, at least one second signaling indicating antenna port related information; and determine at least one of: a second set of resource element of CSI-RS, application time of the antenna port related information or a set of CSI reference resource based on at least one of the first at least one signaling or the at least one second signaling.

According to some embodiments of the present application, the apparatus 800 is a remote apparatus, e.g., a UE, which includes: a transceiver; and a processor coupled to the transceiver, wherein the processor is configured to: receive, via the transceiver, at least one first signaling indicating a first set of resource element of CSI-RS; receive, via the transceiver, at least one second signaling indicating antenna port related information; and determine at least one of: a second set of resource element of CSI-RS, application time of the antenna port related information or a set of CSI reference resource based on at least one of the at least one first signaling or the at least one second signaling.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a.” “an,” or the like does not, without more constraints, preclude the existence of additional identical elements in the process, method, article, or apparatus that includes the element. Also, the term “another” is defined as at least a second or more. The terms “having.” and the like, as used herein, are defined as “including.”

1. A remote apparatus, comprising:
at least one memory; and
at least one processor coupled with the at least one memory and configured to cause the remote apparatus to:
receive at least one first signaling indicating a first set of resource element of channel state information (CSI)-reference signal (RS);
receive at least one second signaling indicating antenna port related information; and
determine a second set of resource element of CSI-RS based on at least one of the at least one first signaling and the at least one second signaling.

2. The remote apparatus of claim 1, wherein, response to an antenna port number determined based on the at least one first signaling being larger than that determined based on the at least one second signaling, the second set of resource element of CSI-RS is determined at least based on the at least one second signaling.

3. The remote apparatus of claim 1, wherein the antenna port related information indicates a row index of a table for CSI-RS locations within a slot, and the at least one processor is configured to cause the remote apparatus to: determine an antenna port number based on the row index.

4. The remote apparatus of claim 1, wherein the antenna port related information indicates an antenna port number.

5. The remote apparatus of claim 4, wherein the second set of resource element of CSI-RS is determined based on an index of a set of row indices of a table for CSI-RS locations within a slot, and the set of row indices is determined based on the antenna port number.

6. The remote apparatus of claim 4, wherein the second set of resource element of CSI-RS is determined based on the first set of resource element of CSI-RS and a third set of resource element of CSI-RS, wherein the third set of resource element of CSI-RS is determined based on an index of a set of row indices in a table for CSI-RS locations within a slot, and the set of row indices is determined by the antenna port number.

7. The remote apparatus of claim 1, wherein the at least one processor is configured to cause the remote apparatus to:
receive a third signaling indicating the second set of resource element of CSI-RS associated with the antenna port related information.

8. The remote apparatus of claim 1, wherein a subcarrier index of the second set of resource element is configured or is determined by the at least one first signaling, or is determined by a predefined or lowest subcarrier index determined by the at least one first signaling.

9. The remote apparatus of claim 1, wherein the application time of the antenna port related information is determined by a delay predefined or configured between reception of the at least one second signaling and application of the at least one second signaling.

10. The remote apparatus of claim 1, wherein the antenna port related information is valid until new antenna port related information is applied.

11. The remote apparatus of claim 1, wherein the second set of signaling is associated with a predefined or configured duration, and the antenna port related information is valid starting from the application time and ending at the application time plus the duration.

12. The remote apparatus of claim 1, wherein the set of CSI reference resource is divided into two subsets of CSI reference resource, and the first subset of CSI reference resource is before application of the at least one second signaling, and the second subset of CSI reference resource is after the application of the at least one second signaling.

13. The remote apparatus of claim 12, wherein, in response to a CSI reporting being after the application of the at least one second signaling, and CSI reference resources for the CSI reporting belong to the first subset of CSI reference resource and the second subset of CSI reference resource, a report metric of the CSI reporting is based on the second subset of CSI reference resource.

14. A radio access network (RAN) node, comprising:
at least one memory; and
at least one processor coupled with the at least one memory and configured to cause the RAN node to:
transmit at least one first signaling indicating a first set of resource element of channel state information (CSI)-reference signal (RS);
transmit at least one second signaling indicating antenna port related information; and
determine a second set of resource element of CSI-RS based on at least one of the at least one first signaling or the at least one second signaling.

15. A method performed by a remote apparatus, the method comprising:
receive at least one first signaling indicating a first set of resource element of channel state information (CSI)-reference signal (RS);
receive at least one second signaling indicating antenna port related information; and
determine a second set of resource element of CSI-RS based on at least one of the at least one first signaling or the at least one second signaling.

16. A processor for wireless communication, comprising:
at least one controller coupled with at least one memory and configured to cause the processor to:
receive at least one first signaling indicating a first set of resource element of channel state information (CSI)-reference signal (RS);
receive at least one second signaling indicating antenna port related information; and
determine a second set of resource element of CSI-RS based on at least one of the at least one first signaling and the at least one second signaling.

17. The processor of claim 16, wherein, in response to an antenna port number determined based on the at least one first signaling being larger than that determined based on the at least one second signaling, the second set of resource element of CSI-RS is determined at least based on the at least one second signaling.

18. The processor of claim 16, wherein the antenna port related information indicates a row index of a table for CSI-RS locations within a slot, and the at least one controller is configured to cause the apparatus to: determine an antenna port number based on the row index.

19. The processor of claim 16, wherein the antenna port related information indicates an antenna port number.

20. The processor of claim 19, wherein the second set of resource element of CSI-RS is determined based on an index of a set of row indices of a table for CSI-RS locations within a slot, and the set of row indices is determined based on the antenna port number.
